(19) United States
(12) Patent Application Publication
(10) Pub. No.: US 2026/0369199 A1
(43) Pub. Date: Nov. 19, 2026

(54) DISPLAY PANEL AND DRIVING METHOD THEREFOR, AND DISPLAY APPARATUS

(71) Applicants: Chengdu BOE Optoelectronics Technology Co., Ltd., Chengdu (CN); BOE Technology Group Co., Ltd., Beijing (CN)

(72) Inventor: Tsanghong WANG, Beijing (CN)

(21) Appl. No.: 19/731,007

(22) Filed: Jul. 4, 2026

Related U.S. Application Data
(63) Continuation of application No. PCT/CN2025/070125, filed on Jan. 2, 2025.

(30) Foreign Application Priority Data
Jan. 29, 2024 (CN) 202410122715.8

(51) Int. Cl. G09G 3/20

(52) U.S. Cl. CPC G09G 3/20; G09G 2300/0452; G09G 2310/0297; G09G 2310/08; G09G 2320/0233

(57) ABSTRACT

A display panel includes a plurality of pixel units and a source driving module. The plurality of pixel units are arranged in an array on the display panel. The source driving module includes a data driving chip and a plurality of demultiplexing circuits. The data driving chip includes a plurality of output ports, each of which is connected to a plurality of demultiplexing circuits and outputs a plurality of precharge signals and data signals to data lines under the control of the plurality of demultiplexing circuits. Two data lines control a column of pixel units.

This application is a continuation of PCT Application No. PCT/CN2025/070125, filed on

Jan. 2, 2025, which claims priority to Chinese Patent Application No. 202410122715.8, filed on Jan. 29, 2024, the disclosures of which are herein incorporated by reference in their entireties.

### TECHNICAL FIELD

The present disclosure relates to the technical field of display technology, and more particularly, to a display panel, a driving method thereof, and a display device.

### BACKGROUND

In display devices such as liquid crystal displays (LCDs) or organic light emitting displays (OLEDs), multiple pixels arranged in an array are included. When the display device is in operation, a data chip needs to output pixel voltages to pixel units through many data transmission lines.

To reduce the number of data transmission lines, a demultiplexing (DEMUX) sub-circuit is provided between the data chip and each data transmission line. Several MUX control lines are used to control the conduction of multiple thin film transistors in the demultiplexing sub-circuit, so that each data transmission line can be connected to multiple pixel units through the demultiplexing sub-circuit, thereby reducing the number of ports on the data driving chip.

However, in the existing double dateline multi-MUX architecture, the charging sequence for the same color corresponding to multiple MUXes is different, resulting in different compensation times, which can lead to luminance differences and subsequently affect the display effect.

### SUMMARY

The purpose of the present disclosure is to provide a display panel with uniform luminance and good display effect, a driving method thereof, and a display device.

The present disclosure discloses a display panel, which includes:

A plurality of pixel units, wherein a plurality of said pixel units are arranged in an array on a display panel;

The source driving module includes a data driving chip and multiple demultiplexing circuits; the data driving chip includes multiple output ports, each of which is connected to multiple demultiplexing circuits and outputs multiple precharge signals and data signals to data lines under the control of these demultiplexing circuits;

Two data lines control a column of the pixel units.

Optionally, the display panel further includes:

A gate driving module, wherein the gate driving module outputs a gate drive signal to a gate line, and one row of the gate line controls one row of pixel units;

One of the two data lines controls the Pixel units in odd rows, and the other controls the Pixel units in even rows;

The demultiplexing circuit controls the data driving chip to output the precharge signal before the active-level period of the gate drive signal;

The demultiplexing circuit controls the data driving chip to output the data signal during the active-level period of the gate drive signal.

Optionally, two adjacent rows of the gate lines form one group, and the gate drive signals of the gate lines in the same group have a same phase. The gate drive signals of the gate lines in the next group lag the gate drive signals of the gate lines in the current group by one phase.

Optionally, a plurality of the pixel units include:

a first pixel unit of a first color, a second pixel unit of a second color, and a third pixel unit of a third color, wherein the first color, the second color, and the third color are different;

In odd rows, the pixel units are arranged periodically in the order of the first pixel unit, the second pixel unit, the third pixel unit, and then the second pixel unit again; in even rows, the pixel units are arranged periodically in the order of the third pixel unit, the second pixel unit, the first pixel unit, and then the second pixel unit again.

Optionally, each of the output ports is connected to four demultiplexing circuits, generating four precharge signals and four data signals; the four precharge signals form one group, the four data signals form one group, and the four data lines form one group; a group of data lines receives a group of precharge signals and a group of data signals; a group of precharge signals is output before the active-level period of the gate drive signal corresponding to a group of gate lines, and a group of data signals is output during the active-level period of the gate drive signal corresponding to a group of gate lines.

Optionally, a plurality of the pixel units includes:

a first pixel unit of a first color, a second pixel unit of a second color, and a third pixel unit of a third color, wherein the first color, the second color, and the third color are different;

The pixel units in odd rows are arranged periodically in the order of the first pixel unit, the second pixel unit, and the third pixel unit; the pixel units in even rows are arranged periodically in the order of the third pixel unit, the second pixel unit, and the first pixel unit.

Optionally, each of the output ports is connected to three demultiplexing circuits, generating three precharge signals and three data signals; the three precharge signals form one group, the three data signals form one group, and the three data lines form one group; a group of data lines receives a group of precharge signals and a group of data signals; a group of precharge signals is output before the active-level period of the gate drive signal corresponding to a group of gate lines, and a group of data signals is output during the active-level period of the gate drive signal corresponding to a group of gate lines.

Optionally, a plurality of the pixel units include:

The first pixel unit of the first color, the second pixel unit of the second color, and the third pixel unit of the third color, where the first color, the second color, and the third color are different;

The pixel units in each row are arranged periodically in the order of the third pixel unit, the second pixel unit, and the first pixel unit.

Optionally, the gate drive signal of the gate line in the next row lags behind the gate drive signal of the gate line in the current row by half a phase.

Optionally, each of the output ports is connected to six demultiplexing circuits, generating six precharge signals and six data signals. Among the six precharge signals, three precharge signals form one group, and among the six data signals, three data signals form one group. Three data lines form one group, and one of the two adjacent groups of data lines receives one group of precharge signals and data signals, and the other group of data lines receives another group of precharge signals and data signals. One group of data signals is output in the first half of the active-level period of a corresponding group of gate drive signals, and the other group of data signals is output in the second half of the active-level period of a corresponding group of gate drive signals.

The present disclosure also discloses a driving method for a display panel, wherein the display panel includes:

Multiple pixel units, wherein a plurality of the pixel units are arranged in an array on a display panel;

A source driving module, wherein the source driving module includes a data driving chip and a plurality of demultiplexing circuits; the data driving chip includes a plurality of output ports, each of which is connected to a plurality of the demultiplexing circuits and outputs signals to data lines under the control of the plurality of demultiplexing circuits; two data lines control a column of the pixel units; one of the two data lines controls the pixel units in odd rows, and the other controls the pixel units in even rows;

A gate driving module, wherein the gate driving module outputs a gate drive signal to a gate line; a row of the gate lines controls a row of the pixel units;

The driving method includes:

Each of the output ports outputs multiple precharge signals to the data lines under the control of multiple demultiplexing circuits, and the phases of these precharge signals precede the active-level periods of the corresponding gate driving signals;

Each of the output ports outputs multiple data signals to the data lines under the control of multiple demultiplexing circuits, and the phases of the multiple data signals are located in the active-level periods corresponding to the gate driving signals.

Optionally, two adjacent rows of the gate lines are grouped together. The gate drive signals controlling the gate lines in the same group have the same phase, and the gate drive signal controlling the gate lines in the next group lags by one phase the gate drive signal controlling the gate lines in the current group;

Each of the output ports is connected to four demultiplexing circuits, which control the output ports to generate four precharge signals and four data signals; the four precharge signals form one group, the four data signals form one group, and the four data lines form one group;

Control a group of the data lines to receive a group of the precharge signals and a group of the data signals; control a group of the precharge signals to be output before the active-level period of the gate drive signal corresponding to a group of the gate lines, and control a group of the data signals to be output during the active-level period of the gate drive signal corresponding to a group of the gate lines.

Optionally, two adjacent rows of the gate lines form one group, and the gate drive signals controlling the gate lines in the same group have the same phase, and the gate drive signal controlling the gate lines in the next group lags by one phase compared to the gate drive signal controlling the gate lines in the current group;

Each of the output ports is connected to three demultiplexing circuits, which control the output ports to generate three precharge signals and three data signals; the three precharge signals form one group, the three data signals form one group, and the three data lines form one group;

Control two adjacent groups of the data lines to receive the same group of the precharge signals and the same group of the data signals; control one group of the precharge signals to be output before the active-level period of the gate drive signal corresponding to one group of the gate lines, and control one group of the data signals to be output during the active-level period of the gate drive signal corresponding to one group of the gate lines.

Optionally, the gate drive signal controlling the gate line in the next row lags behind the gate drive signal controlling the gate line in the current row by half a phase;

Each of the output ports is connected to six demultiplexing circuits, which control the output ports to generate six precharge signals and six data signals. Among the six precharge signals, three precharge signals form one group, and among the six data signals, three data signals form one group. Three data lines form one group;

Control one of the two adjacent groups of data lines to receive one group of precharge signals and data signals, and control the other group of data lines to receive another group of precharge signals and data signals;

Control one group of the data signals to be output in the first half of the active-level period corresponding to one group of the gate drive signals, and control another group of the data signals to be output in the second half of the active-level period corresponding to another group of the gate drive signals.

The present disclosure further discloses a display device, which includes the aforementioned display panel.

Compared with related technologies, the present disclosure controls the driving chip to output precharge signals and data signals to data lines through a demultiplexing circuit, which solves the problem of luminance differences caused by different compensation times due to different charging sequences corresponding to the same color in the double dataline multi-MUX architecture.

It should be understood that the general description above and the detailed descriptions that follow are merely exemplary and explanatory, and do not limit this specification.

### BRIEF DESCRIPTION OF DRAWINGS

The accompanying drawings herein are incorporated into and form a part of this specification, illustrating embodiments consistent with this specification, and are used together with the specification to explain the principles of this specification.

FIG. 1 is a schematic structural diagram of a display panel in an embodiment of the present disclosure.

FIG. 2 is a schematic structural diagram of a display panel in an embodiment of the present disclosure.

FIG. 3 is a timing diagram of the display panel in FIG. 2.

FIG. 4 is a schematic structural diagram of a display panel in an embodiment of the present disclosure.

FIG. 5 is a timing diagram of the display panel in FIG. 4.

FIG. 6 is a schematic structural diagram of a display panel in an embodiment of the present disclosure.

FIG. 7 is a timing diagram of the display panel in FIG. 6.

### DETAILED DESCRIPTION

Here, exemplary embodiments will be described in detail, with examples illustrated in the accompanying drawings. When the following description refers to the drawings, unless otherwise indicated, the same numerals in different drawings represent the same or similar elements. The implementations described in the following exemplary embodiments do not represent all implementations consistent with this specification. Instead, they are merely examples of devices and methods consistent with certain aspects of this specification, as detailed in the accompanying claims.

The terms used in the present disclosure are solely for the purpose of describing specific embodiments and are not intended to limit the present disclosure. Unless otherwise defined, technical or scientific terms used in this specification shall have the usual meanings understood by those skilled in the art to which the present disclosure pertains. The use of terms such as “first”, “second”, and the like in this specification and claims does not denote any order, quantity, or importance, but merely serves to distinguish different components. Similarly, terms such as “one” or “a” do not denote a limitation on quantity, but rather indicate existence. “Multiple” or “several” indicates two or more. Unless otherwise indicated, terms such as “front”, “rear”, “lower”, and/or “upper” are used for convenience of description only and are not limited to one position or one spatial orientation. Terms such as “including” or “comprising” indicate that the elements or items preceding “including” or “comprising” encompass the elements or items listed after “including” or “comprising” and their equivalents, without excluding other elements or items. Terms such as “connected” or “connected to” are not limited to physical or mechanical connections, but may also include electrical connections, whether direct or indirect.

The terminology used in this specification is solely for the purpose of describing specific embodiments and is not intended to limit the present disclosure. The use of the singular forms “a”, “an”, “the”, and “a kind of” in this specification and the accompanying claims is also intended to include the plural form, unless the context clearly indicates otherwise. It should also be understood that the term “and/or” as used herein refers to and includes any and all possible combinations of one or more of the associated listed items.

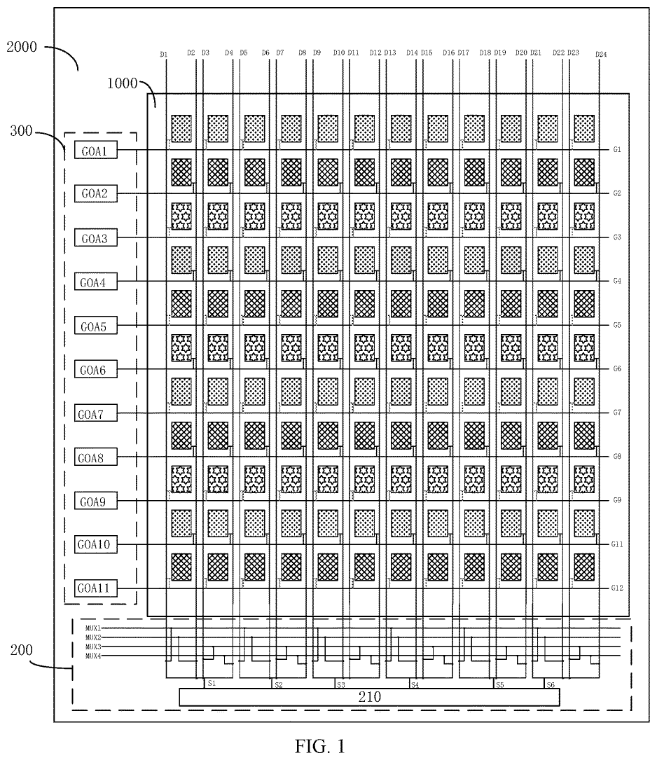

As shown in FIG. 1, the present disclosure provides a display panel, which includes:

a plurality of pixel units 100 which are arranged in an array on a display panel;

a source driving module 200, which includes a data driving chip 210 and a plurality of demultiplexing circuits; and the data driving chip 210 includes a plurality of output ports, each of the plurality of output ports is connected to the plurality of the demultiplexing circuits and outputs a plurality of precharge signals and data signals to data lines under the control of the plurality of the demultiplexing circuits; and

two data lines control a column of the pixel units 100.

The present application addresses the problem of luminance differences caused by inconsistent charging sequences for the same color corresponding to multiple MUXes in a double dataline multi-MUX architecture, by controlling the demultiplexing circuit to output a precharge signal and a data signal from the data driver chip to the data lines..

The following will provide a detailed description of various embodiments of the present disclosure that conform to the aforementioned creative concept.

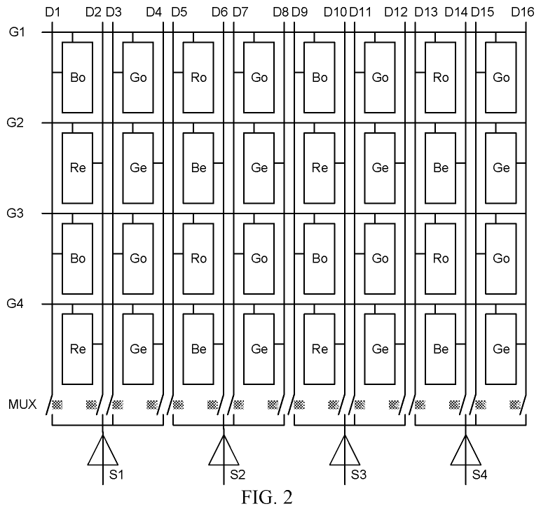

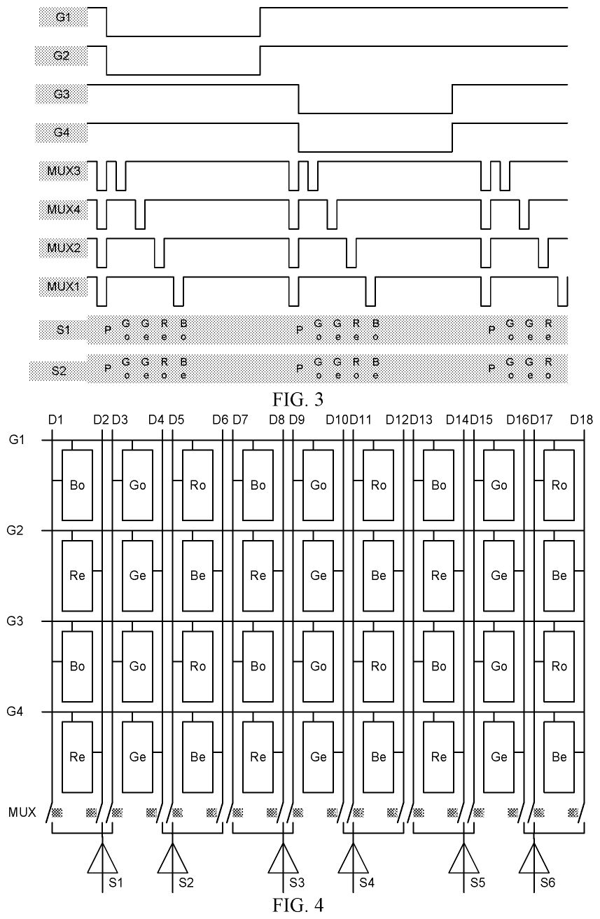

As shown in FIGS. 1 to 3, the present disclosure provides a display panel. The display panel includes a display region 1000 and a non-display region 2000 arranged around the display region 1000.

A plurality of pixel units 100 are arranged within the display region 1000. The plurality of pixel units 100 are arranged in an array within the display region 1000. For example, in a rectangular display panel, the plurality of pixel units 100 can be arranged in a rectangular array on the display panel. The plurality of pixel units 100 include a first pixel unit in a first color, a second pixel unit in a second color, and a third pixel unit in a third color, where the first color, the second color, and the third color are different from each other. Optionally, the first color can be one of red, green, or blue, the second color can be another one of red, green, or blue, and the third color can be the last one of red, green, or blue. The present disclosure takes the example where the first color is blue, the second color is green, and the third color is red for illustration.

The non-display region 2000 is provided with a source driving module 200 and a gate driving module 300. The source driving module 200 transmits data signals to the pixel units 100 through data lines, so as to drive the pixel units 100 to emit light. The gate driving module 300 transmits gate drive signals to the pixel units 100 through gate lines, so as to control whether the data lines transmit data signals to the pixel units 100. Optionally, the source driving module 200 can be positioned at a bottom of the display panel, and the gate driving module 300 can be positioned at a side of the display panel. Multiple gate lines are uniformly arranged along the column direction on the display panel, each gate line extends along the row direction of the display panel, and one gate line controls a row of pixel units 100. Multiple data lines are arranged along the row direction on the display panel, each data line extends along the column direction of the display panel, and two data lines jointly control a column of pixel units 100.

The source driving module 200 includes a data driving chip 210 and multiple demultiplexing circuits. The data driving chip 210 includes multiple output ports, each of which is connected to multiple demultiplexing circuits and outputs multiple precharge signals and data signals to data lines under the control of the demultiplexing circuits. For instance, the data driving chip 210 includes fifty output terminals (S1, S2, S3 . . . S49, S50), each of the fifty output terminals is connected to four demultiplexing circuits (MUX1, MUX2, MUX3, MUX4). Taking the connection between S1 and the four demultiplexing circuits (MUX1, MUX2, MUX3, MUX4) as an example, S1 generates four precharge signals and four data signals under the control of the demultiplexing circuits, and outputs the four precharge signals to four data lines (D1, D2, D3, D4) respectively, and the four data signals to four data lines (D1, D2, D3, D4) respectively. By analogy, the fifty output terminals (S1, S2, S3 . . . S49, S50) can generate two hundred precharge signals and two hundred data signals. If two data lines drive one column of pixel units 100, one hundred columns of pixel units 100 can be driven by two hundred data lines.

The gate driving module 300 includes a plurality of gate driving units (GOA, Gate Driven on Array) arranged along the column direction of the display panel. The multiple GOA units arranged along the column direction can be cascaded or uncascaded. Each GOA unit is connected to a row of gate lines. The GOA unit generates a gate drive signal and transmits the gate drive signal to the corresponding row of pixel units 100 through the gate line.

The source driving module 200 outputs a precharge signal before an active-level period of a corresponding gate drive signal, and outputs a data signal during the active-level period of the gate drive signal. That is, the demultiplexing circuit controls the data driving chip 210 to output a precharge signal before the active-level period of the gate drive signal and to output a data signal during the active-level period of the gate drive signal.

As shown in FIGS. 1 to 3, in an alternative embodiment, the pixel units in odd rows are arranged periodically in the order of the first pixel unit, the second pixel unit, the third pixel unit, and the second pixel unit; and the pixel units in even rows are arranged periodically in the order of the third pixel unit, the second pixel unit, the first pixel unit, and the second pixel unit.

That is, the pixel units in odd rows are arranged periodically in the order of blue pixel units, green pixel units, red pixel units, and green pixel units. The pixel units in even rows are arranged periodically in the order of red pixel units, green pixel units, blue pixel units, and green pixel units. G1, G2, . . . , Ga control the pixel units 100 in the first row, second row, . . . , a-th row, respectively, where a is an integer greater than 1. D1 and D2 control the first column, D3 and D4 control the second column, . . . , D2b-1 and D2b control the pixel units 100 in the b-th column, where b is an integer greater than 1. The data lines in odd columns are connected to the pixel units 100 in odd rows in the controlled column, and the data lines in even columns are connected to the pixel units 100 in even rows in the controlled column.

In the gate driving module 300, two adjacent rows of gate lines form one group. The gate drive signals for the same group of gate lines have the same phase, and gate drive signals for the next group of gate lines lag the gate drive signals for the current group of gate lines by one phase. For example, G1 and G2 form one group, G3 and G4 form one group, and so on. G2a-1 and G2a form the same group, where a is an integer greater than 1. Gate drive signals for the same group of gate lines have the same phase, and gate drive signals for the next group of gate lines lag the gate drive signals for the current group of gate lines by one phase. That is, the gate drive signals output by GOA2a-1 and GOA2a have the same phase, and the gate drive signals output by G2a-1 and G2a lag the gate drive signals output by G2a-3 and G2a-2 by one phase. Here, a is an integer greater than 1.

In the source driving module 200, each output port (S1, S2, . . . ) of the gate driving chip 210 is connected to four demultiplexing circuits (MUX1, MUX2, MUX3, MUX4), and four precharge signals and four data signals are generated. The four precharge signals form one group, the four data signals form one group, and the four data lines form one group. One group of data lines receives one group of precharge signals and one group of data signals. One group of precharge signals is output before the active-level period of the gate drive signal corresponding to one group of gate lines, and another group of precharge signals is output during the active-level period of the gate drive signal corresponding to one group of gate lines. For example, S1 is connected to MUX1, MUX2, MUX3, and MUX4, and four precharge signals and four data signals are generated under the control of MUX1, MUX2, MUX3, and MUX4. The four precharge signals are output to D1, D2, D3, and D4 before the active-level period of the gate drive signal, respectively, and the four data signals are output to D1, D2, D3, and D4 during the active-level period of the gate drive signal, respectively. Optionally, phases of the four precharge signals output to D1, D2, D3, and D4 are synchronized. Phases of the four data signals output to D1, D2, D3, and D4 are sequentially lagged in the order of D3, D4, D2, and D1.

Specifically, S1 is connected to MUX1, MUX2, MUX3, and MUX4, and four precharge signals and four data signals are generated under the control of MUX1, MUX2, MUX3, and MUX4. The four precharge signals are output to D1, D2, D3, and D4, respectively, before the active-level period of G1 and G2. The four data signals are output to D1, D2, D3, and D4, respectively, during the active-level period of G1 and G2. Optionally, phases of the four precharge signals output to D1, D2, D3, and D4 are synchronized. Phases of the four data signals output to D1, D2, D3, and D4 are sequentially lagged in the order of D3, D4, D2, and D1.

S2 is connected to MUX1, MUX2, MUX3, and MUX4, and four precharge signals and four data signals are generated under the control of MUX1, MUX2, MUX3, and MUX4. The four precharge signals are output to D5, D6, D7, and D8 respectively before the active-level period of G1 and G2. The four data signals are output to D5, D6, D7, and D8 respectively during the active-level period of G1 and G2. Optionally, phases of the four precharge signals output to D5, D6, D7, and D8 are synchronized. Phases of the four data signals output to D5, D6, D7, and D8 are sequentially lagged in the order of D7, D8, D5, and D6.

S2n-1 is connected to MUX1, MUX2, MUX3, and MUX4, and four precharge signals and four data signals are generated under the control of MUX1, MUX2, MUX3, and MUX4. The four precharge signals are output to D8n-7, D8n-6, D8n-5, and D8n-4, respectively, before the active-level period of G1 and G2. The four data signals are output to D8n-7, D8n-6, D8n-5, and D8n-4, respectively, during the active-level period of G1 and G2. Optionally, phases of the four precharge signals output to D8n-7, D8n-6, D8n-5, and D8n-4 are synchronized. Phases of the four data signals output to D8n-7, D8n-6, D8n-5, and D8n-4 are sequentially lagged in the order of D8n-5, D8n-4, D8n-6, and D8n-7, and n is an integer greater than 1.

S2n is connected to MUX1, MUX2, MUX3, and MUX4, and four precharge signals and four data signals are generated under the control of MUX1, MUX2, MUX3, and MUX4. The four precharge signals are output to D8n-3, D8n-2, D8n-1, and D8n before the active-level period of G1 and G2, respectively. The four data signals are output to D8n-3, D8n-2, D8n-1, and D8n during the active-level period of G1 and G2, respectively. Optionally, phases of the four precharge signals output to D8n-3, D8n-2, D8n-1, and D8n are synchronized. Phases of the four data signals output to D8n-3, D8n-2, D8n-1, and D8n are sequentially lagged in the order of D8n-1, D8n, D8n-3, and D8n-2 and n is an integer greater than 1.

In this way, the scanning and light emission of the pixel units 100 in the first and second rows are completed. By analogy, the pixel units 100 in other rows are scanned and emit light level by level according to the phase sequence of the GOA signal in each row.

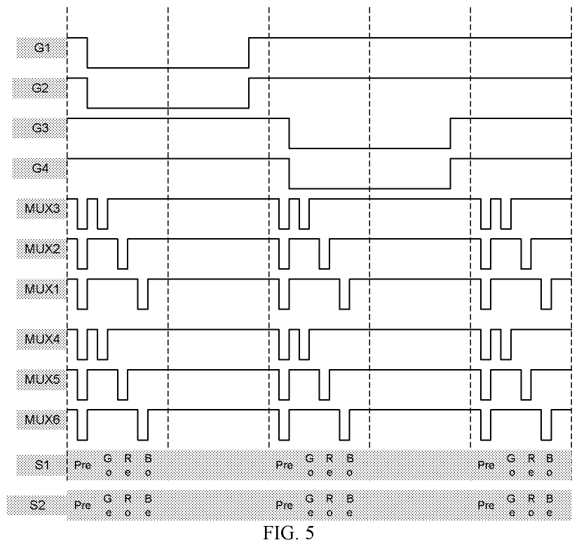

As shown in FIGS. 1, 4, and 5, in an alternative embodiment, the pixel units in odd rows are arranged periodically in the order of the first pixel unit, the second pixel unit, and the third pixel unit. The pixel units in even rows are arranged periodically in the order of the third pixel unit, the second pixel unit, and the first pixel unit. That is, the pixel units in odd rows are arranged periodically in the order of blue pixel units, green pixel units, and red pixel units, and the pixel units in even rows are arranged periodically in the order of red pixel units, green pixel units, and blue pixel units. G1, G2, . . . , Ga control the pixel units 100 in the first row, the second row, . . . , the a-th row, respectively, where a is an integer greater than 1. D1 and D2 control the first column, D3 and D4 control the second column, . . . , D2b-1 and D2b control the pixel units 100 in the b-th column, where b is an integer greater than 1. The data lines in the odd columns are connected to the pixel units 100 in the odd rows of the controlled column, and the data lines in the even columns are connected to the pixel units 100 in the even rows of the controlled column.

In the gate driving module 300, two adjacent rows of gate lines form one group. The gate drive signals for the gate lines in the same group have the same phase, and the gate drive signals for the next group of gate lines lag the gate drive signals for the current group of gate lines by one phase. For example, G1 and G2 form one group, G3 and G4 form one group, and so on. G2a-1 and G2a form the same group, where a is an integer greater than 1. The gate drive signals for the gate lines in the same group have the same phase, and the gate drive signals for the next group of gate lines lag the gate drive signals for the current group of gate lines by one phase. That is, the gate drive signals output by GOA2a-1 and GOA2a have the same phase, and the gate drive signals output by G2a-1 and G2a lag the gate drive signals output by G2a-3 and G2a-2. Here by one phase, a is an integer greater than 1.

In the source driving module 200, each output port (S1, S2, . . . ) of the gate driving chip 210 is connected to three demultiplexing circuits (MUX1, MUX2, MUX3), and three precharge signals and three data signals are generated. The three precharge signals form one group, the three data signals form one group, and the three data lines form one group. One group of data lines receives one group of precharge signals and one group of data signals. One group of precharge signals is output before the active-level period of the gate drive signal corresponding to one group of gate lines, and one group of precharge signals is output during the active-level period of the gate drive signal corresponding to one group of gate lines.

For example, S1 is connected to MUX1, MUX2, and MUX3, and three precharge signals and three data signals are generated under the control of MUX1, MUX2, MUX3, and MUX4. The three precharge signals are output to D1, D2, and D3 respectively before the active-level period of the gate drive signal, and the three data signals are output to D1, D2, and D3 respectively during the active-level period of the gate drive signal. Optionally, phases of the three precharge signals output to D1, D2, and D3 are synchronized. Phases of the three data signals output to D1, D2, and D3 are sequentially lagged in the order of D3, D2, and D1.

Specifically, S1 is connected to MUX1, MUX2, and MUX3, and three precharge signals and three data signals are generated under the control of MUX1, MUX2, and MUX3. The three precharge signals are output to D1, D2, and D3 respectively before the active-level period of G1 and G2. The three data signals are output to D1, D2, and D3 respectively during the active-level period of G1 and G2. Optionally, phases of the three precharge signals output to D1, D2, and D3 are synchronized. Phases of the three data signals output to D1, D2, and D3 are sequentially lagged in the order of D3, D2, and D1.

S2 is connected to MUX1, MUX2, and MUX3, and three precharge signals and three data signals are generated under the control of MUX1, MUX2, and MUX3. The three precharge signals are output to D4, D5, and D6 respectively before the active-level period of G1 and G2. The three data signals are output to D4, D5, and D6 respectively during the active-level period of G1 and G2. Optionally, phases of the three precharge signals output to D4, D5, and D6 are synchronized. Phases of the three data signals output to D4, D5, and D6 are sequentially lagged in the order of D4, D5, and D6.

S2n-1 is connected to MUX1, MUX2, and MUX3, and three precharge signals and three data signals are generated under the control of MUX1, MUX2, and MUX3. The three precharge signals are output to D6n-5, D6n-4, and D6n-3, respectively, before the active-level period of G1 and G2. The three data signals are output to D6n-5, D6n-4, and D6n-3, respectively, during the active-level period of G1 and G2. Optionally, phases of the three precharge signals output to D6n-5, D6n-4, and D6n-3 are synchronized. Phases of the three data signals output to D6n-5, D6n-4, and D6n-3 are sequentially lagged in the order of D6n-3, D6n-4, and D6n-5 and n is an integer greater than 1.

S2n is connected to MUX1, MUX2, and MUX3, and three precharge signals and three data signals are generated under the control of MUX1, MUX2, and MUX3. The three precharge signals are output to D6n-2, D6n-1, and D6n respectively before the active-level period of G1 and G2. The three data signals are output to D6n-2, D6n-1, and D6n respectively during the active-level period of G1 and G2. Optionally, phases of the three precharge signals output to D6n-2, D6n-1, and D6n are synchronized. Phases of the three data signals output to D6n-2, D6n-1, and D6n are sequentially lagged in the order of D6n-2, D6n-1, and D6n and n is an integer greater than 1.

In this way, the scanning and light emission of the pixel units 100 in the first and second rows are completed. By analogy, the pixel units 100 in other rows are scanned and emit light level by level according to the phase sequence of the GOA signal in each row.

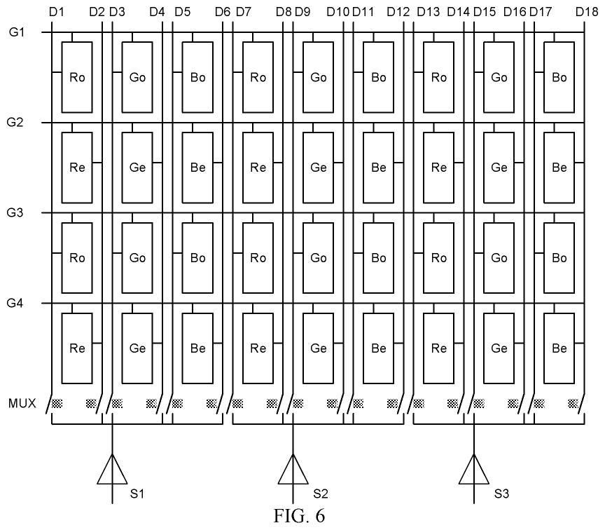

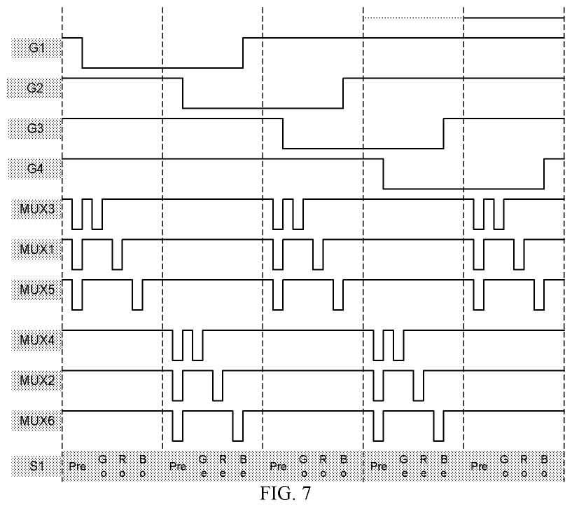

As shown in FIGS. 1, 6, and 7, in an alternative embodiment, each row of pixel units is arranged periodically in the order of the third pixel unit, the second pixel unit, and the first pixel unit. That is, each row of pixel units is arranged periodically in the order of red pixel units, green pixel units, and blue pixel units. G1, G2, . . . , Ga control the first row, the second row, . . . , the a-th row of pixel units 100, respectively, where a is an integer greater than 1. D1 and D2 control the first column, D3 and D4 control the second column, . . . , D2b-1 and D2b control the b-th column of pixel units 100, where b is an integer greater than 1. The data lines of odd columns are connected to the odd-row pixel units 100 in the controlled column, and the data lines of even columns are connected to the even-row pixel units 100 in the controlled column.

In the gate driving module 300, the gate drive signal for the next row of gate line lags the gate drive signal for the current row of gate line by half a phase. For example, the gate drive signal for G2 lags the gate drive signal for G1 by half a phase, and the gate drive signal for Ga lags the gate drive signal for Ga-1 by half a phase. That is, the gate drive signal output by GOAa lags the gate drive signal output by GOAa-1 by half a phase. The first half of the active-level period of the gate drive signal output by GOAa overlaps with the second half of the active-level period of the gate drive signal output by GOAa-1, where a is an integer greater than 1.

In the source driving module 200, each output port (S1, S2, . . . ) of the gate driving chip 210 is connected to six demultiplexing circuits (MUX1, MUX2, MUX3, MUX4, MUX5, MUX6), and six precharge signals and six data signals are generated. Among the six precharge signals, three precharge signals form one group; among the six data signals, three data signals form one group; and three data lines form one group. Among two adjacent groups of data lines, one group of data lines receives one group of precharge signals and data signals, and the other group of data lines receives another group of precharge signals and data signals. One group of data signals is output in the first half of the active-level period of a corresponding group of gate driving signals, and the other group of data signals is output in the second half of the active-level period of a corresponding group of gate driving signals.

For example, S1 is connected to MUX1, MUX2, MUX3, MUX4, MUX5, and MUX6, and six precharge signals and six data signals are generated under the control of MUX1, MUX2, MUX3, MUX4, MUX5, and MUX6. Among the six precharge signals, three precharge signals generated by MUX1, MUX3, and MUX5 form one group, and three precharge signals generated by MUX2, MUX4, and MUX6 form another group. Among the six data signals, three data signals generated by MUX1, MUX3, and MUX5 form one group, and three data signals generated by MUX2, MUX4, and MUX6 form another group. In two adjacent groups of data lines, one group of data lines receives one group of precharge signals and data signals, and the other group of data lines receives another group of precharge signals and data signals. One group of data signals is output in the first half of the active-level period of a corresponding group of gate drive signals, and the other group of data signals is output in the second half of the active-level period of a corresponding group of gate drive signals. One group of precharge signals is output to one group of data lines before the active-level period of the gate drive signals, and the two groups of data signals are output to the two groups of data lines during the active-level period of the gate drive signals, respectively. Optionally, the phases of the precharge signals in the same group among the six precharge signals are synchronized. The phase sequence of the six data signals is sequentially lagged.

Specifically, S1 is connected to MUX1, MUX2, MUX3, MUX4, MUX5, and MUX6, and six precharge signals and six data signals are generated under their control. The six precharge signals and six data signals generated under the control of MUX1, MUX2, MUX3, MUX4, MUX5, and MUX6 are output to D1, D2, D3, D4, D5, and D6 in sequence. The precharge signals and data signals generated by MUX1, MUX3, and MUX5 form the first group, and the precharge signals and data signals generated by MUX2, MUX4, and MUX6 form the second group.

The precharge signals of the first group are output to D1, D2, and D3 respectively before the active-level period of G1, and the data signals of the first group are output to D1, D3, and D5 respectively during the active-level period of G1. Specifically, the data signals of the first group are output to D1, D3, and D5 respectively in the first half of the active-level period of G1. Optionally, phases of the three precharge signals output to D1, D3, and D5 are synchronized. The phases of the three data signals output to D1, D3, and D5 are sequentially lagged in the order of D3, D1, and D5.

The precharge signals of the second group are output to D2, D4, and D6 during the active-level period of G1, respectively. The data signals of the second group are output to D2, D4, and D6 during the active-level period of G1. Specifically, the data signals of the second group are output to D2, D4, and D6 during the second half of the active-level period of G1, respectively. The precharge signals of the second group are output to D2, D4, and D6 between the data signals of the first group and the data signals of the second group. Optionally, the three precharge signals output to D2, D4, and D6 are phase-synchronized. The three data signals output to D2, D4, and D6 are sequentially lagged in phase, following the order of D4, D2, and D6.

S2 is connected to MUX1, MUX2, MUX3, MUX4, MUX5, and MUX6, and six precharge signals and six data signals are generated under the control of these MUXes. The six precharge signals and six data signals generated under the control of MUX1, MUX2, MUX3, MUX4, MUX5, and MUX6 are output sequentially to D7, D8, D9, D10, D11, and D12, respectively. The precharge signals and data signals generated by MUX1, MUX3, and MUX5 form the first group, and the precharge signals and data signals generated by MUX2, MUX4, and MUX6 form the second group.

The precharge signals of the first group are output to D7, D9, and D11 respectively before the active-level period of G1, and the data signals of the first group are output to D7, D9, and D11 respectively during the active-level period of G1. Specifically, the data signals of the first group are output to D7, D9, and D11 respectively in the first half of the active-level period of G1. Optionally, the three precharge signals output to D7, D9, and D11 are phase-synchronized. The three data signals output to D7, D9, and D11 are sequentially lagged in phase in the order of D9, D7, and D11.

The precharge signals and the data signals of the second group are output to D8, D10, and D12 during the active-level period of G1, respectively. Specifically, the data signals of the second group are output to D8, D10, and D12 during the second half of the active-level period of G1, respectively. Meanwhile, the precharge signals of the second group are output to D8, D10, and D12 between the data signals of the first group and the data signals of the second group, respectively. Optionally, the three precharge signals output to D8, D10, and D12 are phase-synchronized. The three data signals output to D8, D10, and D12 are sequentially lagged in phase, following the order of D10, D8, and D12.

Sn is connected to MUX1, MUX2, MUX3, MUX4, MUX5, and MUX6, and six precharge signals and six data signals are generated under the control of MUX1, MUX2, MUX3, MUX4, MUX5, and MUX6. The six precharge signals and six data signals generated under the control of MUX1, MUX2, MUX3, MUX4, MUX5, and MUX6 are output to D6n-5, D6n-4, D6n-3, D6n-2, D6n-1, and D6n in sequence. The precharge signals and data signals generated by MUX1, MUX3, and MUX5 form the first group, and the precharge signals and data signals generated by MUX2, MUX4, and MUX6 form the second group and n is an integer greater than 1.

The precharge signals of the first group are output to D6n-5, D6n-3, and D6n-1 respectively before the active-level period of G1, and the data signals of the first group are output to D6n-5, D6n-3, and D6n-1 respectively during the active-level period of G1. Specifically, the data signals of the first group are output to D6n-5, D6n-3, and D6n-1 respectively in the first half of the active-level period of G1. Optionally, the phases of the three precharge signals output to D6n-5, D6n-3, and D6n-1 are synchronized. The three data signals output to D6n-5, D6n-3, and D6n-1 are sequentially lagged in phase in the order of D6n-3, D6n-5, and D6n-1.

The precharge signals and the data signals of the second group are output to D6n-4, D6n-2, and D6n during the active-level period of G1, respectively. Specifically, the data signals of the second group are output to D6n-4, D6n-2, and D6n during the second half of the active-level period of G1, respectively. Meanwhile, the precharge signals of the second group are output to D6n-4, D6n-2, and D6n between the data signals of the first group and those of the second group, respectively. Optionally, the three precharge signals output to D6n-4, D6n-2, and D6n are phase-synchronized. The three data signals output to D6n-4, D6n-2, and D6n are sequentially lagged in phase, following the order of D6n-2, D6n-4, and D6n.

Thus, the scanning and light emission of the first row of pixel units 100 are completed. Since the first half of the active-level period of the gate drive signal output by GOAa overlaps with the second half of the active-level period of the gate drive signal output by GOAa-1, where a is an integer greater than 1, the first group of signals generated by S1 are output to D1, D3, and D5 during the first half of the active-level period of G2n-1, and the second group of data signals generated by S1 are output to D2, D4, and D6 during the second half of the active-level period of G2n-1. The first group of signals generated by S1 are output to D1, D3, and D5 during the second half of the active-level period of G2n, and the second group of data signals generated by S1 are output to D2, D4, and D6 during the first half of the active-level period of G2n. Similarly, the pixel units 100 in other rows are scanned and emit light level by level according to the phase sequence of the GOA signals in each row.

The present disclosure also discloses a driving method for a display panel, wherein the display panel includes:

multiple pixel units, wherein the multiple of the pixel units are arranged in an array on a display panel;

a source driving module, wherein the source driving module includes a data driving chip and a plurality of demultiplexing circuits; the data driving chip includes a plurality of output ports, each of the plurality of output ports is connected to a plurality of the demultiplexing circuits and outputs signals to data lines under the control of the plurality of demultiplexing circuits; two data lines control a column of the pixel units; one of the two data lines controls the pixel units in odd rows, and the other controls the pixel units in even rows;

a gate driving module, wherein the gate driving module outputs a gate drive signal to a gate line; one row of the gate line controls one row of pixel units;

the driving method includes:

each of the output ports outputs multiple precharge signals to the data lines under the control of the multiple demultiplexing circuits, and the phases of the precharge signals precede the active-level periods of the corresponding gate driving signals;

each of the output ports outputs multiple data signals to the data lines under the control of the multiple demultiplexing circuits, and the phases of the multiple data signals are located within the active-level periods corresponding to the gate driving signals.

Optionally, two adjacent rows of the gate lines form one group, the gate drive signals for the gate lines in the same group are controlled to have the same phase, and the gate drive signals for the gate lines in the next group are controlled to lag the gate drive signals for the gate lines in the current group by one phase;

each of the output ports is connected to four demultiplexing circuits, and the four demultiplexing circuits control the output ports to generate four precharge signals and four data signals; the four precharge signals form one group, the four data signals form one group, and the four data lines form one group; and

a group of the data lines is controlled to receive a group of the precharge signals and a group of the data signals; a group of the precharge signals is controlled to be output before the active-level period of the gate drive signal corresponding to a group of the gate lines, and a group of the data signals is controlled to be output in the active-level period of the gate drive signal corresponding to a group of the gate lines.

Optionally, two adjacent rows of the gate lines form one group, the gate drive signals for the gate lines in the same group are controlled to have the same phase, and the gate drive signals for the gate lines in the next group is controlled to lag the gate drive signals for the gate lines in the current group by one phase;

each of the output ports is connected to three multiple demultiplexing circuits, the three multiple demultiplexing circuits control the output ports to generate three precharge signals and three data signals; the three precharge signals form one group, the three data signals form one group, and the three data lines form one group; and

two adjacent groups of the data lines are controlled to receive the same group of the precharge signals and the same group of the data signals; a group of the precharge signals is controlled to be output before the active-level period of the gate drive signal corresponding to a group of the gate lines, and a group of the data signals is controlled to be output in the active-level period of the gate drive signal corresponding to a group of the gate lines.

Optionally, the gate drive signal for the gate line in the next row is controlled to lagged the gate drive signal for the gate line in the current row by half a phase;

each of the output ports is connected to six demultiplexing circuits, the sixdemultiplexing circuits control the output ports to generate six precharge signals and six data signals; among the six precharge signals, three precharge signals form one group; among the six data signals, three data signals form one group; and three data lines form one group;

one group of the two adjacent groups of data lines is controlled to receive one group of precharge signals and data signals, and the other group of data lines is controlled to receive another group of precharge signals and data signals; and

a group of the data signals is controlled to be output in the first half of the active-level period corresponding to a group of the gate drive signals, and another group of the data signals is controlled to be output in the second half of the active-level period corresponding to a group of the gate drive signals.

The present disclosure further discloses a display device, which includes the aforementioned display panel.

After considering the specification and practicing the invention applied for herein, those skilled in the technical field will easily conceive of other implementation schemes of this specification. This specification aims to cover any variations, uses, or adaptations of this specification, which follow the general principles of this specification and include common general knowledge or conventional technical means in the technical field not applied for in this specification. The specification and embodiments are only considered exemplary, and the true scope and spirit of this specification are indicated by the following claims.

It should be understood that this specification is not limited to the precise structure that has been described above and illustrated in the accompanying drawings, and various modifications and changes can be made without departing from its scope. The scope of this specification is limited only by the appended claims.

Described above are merely preferred embodiments of this specification and are not intended to limit it. Any modifications, equivalent substitutions, improvements, or the like, made within the spirit and principle of this specification should fall within the protection scope of this specification.

1. A display panel, comprising:
a plurality of pixel units, wherein the plurality of pixel units are arranged in an array on the display panel; and
a source driving module, wherein the source driving module comprises a data driving chip and a plurality of demultiplexing circuits;
wherein the data driving chip comprises a plurality of output ports, each of the plurality of output ports is connected to the plurality of demultiplexing circuits and outputs a plurality of precharge signals and a plurality of data signals to data lines under control of the plurality of demultiplexing circuits, and two data lines control a column of pixel units.

2. The display panel according to claim 1, wherein the display panel further comprises: a gate driving module, the gate driving module outputs a gate drive signal to a gate line, and one row of the gate line controls one row of pixel units; and wherein
one of the two data lines controls pixel units in odd rows, and the other controls pixel units in even rows;
the demultiplexing circuit controls the data driving chip to output the precharge signal before an active-level period of the gate drive signal; and
the demultiplexing circuit controls the data driving chip to output the data signal during the active-level period of the gate drive signal.

3. The display panel according to claim 2, wherein two adjacent rows of gate lines form one group, gate drive signals for gate lines in a same group have a same phase, and gate drive signals for gate lines in a next group lag gate drive signals for gate lines in a current group by one phase.

4. The display panel according to claim 3, wherein the plurality of pixel units comprise:
a first pixel unit of a first color, a second pixel unit of a second color, and a third pixel unit of a third color, wherein the first color, the second color, and the third color are different; and
the pixel units in odd rows are arranged periodically in an order of the first pixel unit, the second pixel unit, the third pixel unit, and the second pixel unit; and the pixel units in even rows are arranged periodically in an order of the third pixel unit, the second pixel unit, the first pixel unit, and the second pixel unit.

5. The display panel according to claim 4, wherein each of the plurality of output ports is connected to four demultiplexing circuits, and four precharge signals and four data signals are generated;
the four precharge signals form one group, the four data signals form one group, and the four data lines form one group;
a group of data lines receives a group of precharge signals and a group of data signals; and
the group of precharge signals is output before an active-level period of gate drive signals corresponding to a group of gate lines, and the group of data signals is output during the active-level period of the gate drive signals corresponding to the group of gate lines.

6. The display panel according to claim 3, wherein the plurality of pixel units comprises:
a first pixel unit of a first color, a second pixel unit of a second color, and a third pixel unit of a third color, wherein the first color, the second color, and the third color are different; and
the pixel units in odd rows are arranged periodically in an order of the first pixel unit, the second pixel unit, and the third pixel unit; and the pixel units in even rows are arranged periodically in an order of the third pixel unit, the second pixel unit, and the first pixel unit.

7. The display panel according to claim 6, wherein each of the plurality of output ports is connected to three demultiplexing circuits, and three precharge signals and three data signals are generated;
the three precharge signals form one group, the three data signals form one group, and three data lines form one group;
one group of data lines receives a group of precharge signals and a group of data signals; and
the group of precharge signals is output before an active-level period of the gate drive signals corresponding to a group of gate lines, and the group of data signals is output during the active-level period of the gate drive signals corresponding to the group of gate lines.

8. The display panel according to claim 2, wherein the plurality of pixel units comprises:
a first pixel unit of a first color, a second pixel unit of a second color, and a third pixel unit of a third color, wherein the first color, the second color, and the third color are different; and
pixel units in each row are arranged periodically in an order of the third pixel unit, the second pixel unit, and the first pixel unit.

9. The display panel according to claim 8, wherein a gate drive signal for a gate line in a next row lags a gate drive signal for a gate line in a current row by half a phase.

10. The display panel according to claim 9, wherein each of the plurality of output ports is connected to six demultiplexing circuits, and six precharge signals and six data signals are generated;
three precharge signals among the six precharge signals form one group, three data signals among the six data signals form one group, and three data lines form one group;
one of the two adjacent groups of data lines receives a group of precharge signals and data signals, and other group of data lines receives another group of precharge signals and data signals; and
the group of data signals is output in a first half of an active-level period of a corresponding group of gate drive signals, and another group of data signals is output in a second half of the active-level period of a corresponding group of gate drive signals.

11. A driving method for a display panel, wherein the display panel comprises:
a plurality of pixel units, wherein the plurality of the pixel units are arranged in an array on the display panel;
a source driving module, wherein the source driving module comprises a data driving chip and a plurality of demultiplexing circuits;
wherein the data driving chip comprises a plurality of output ports, each of the plurality of output ports is connected to the plurality of the demultiplexing circuits and outputs a signal to a data line under control of the plurality of the demultiplexing circuits; and two data lines control a column of the pixel units; one of the two data lines controls pixel units in odd rows, and the other controls pixel units in even rows;
a gate driving module, wherein the gate driving module outputs a gate drive signal to a gate line; one row of the gate line controls one row of pixel units;
the driving method comprises:
outputting, by each of the plurality of output ports, a plurality of precharge signals to data lines under control of the plurality of demultiplexing circuits, and phases of the plurality of precharge signals precede an active-level period of a corresponding gate driving signal; and
outputting, by each of the plurality of output ports, a plurality of data signals to the data lines under the control of the plurality of demultiplexing circuits, and phases of the plurality of data signals are located within the active-level period of the corresponding gate driving signal.

12. The driving method according to claim 11, wherein two adjacent rows of the gate lines form one group, gate drive signals for gate lines in a same group of are controlled to have a same phase, and gate drive signals for gate lines in a next group are controlled to lag gate drive signals for gate lines in a current group by one phase;
each of the plurality of output ports is connected to four demultiplexing circuits, the four demultiplexing circuits control the output port to generate four precharge signals and four data signals; and the four precharge signals form one group, the four data signals form one group, and four data lines form one group; and
a group of the data lines is controlled to receive a group of the precharge signals and a group of the data signals; the group of the precharge signals is controlled to be output before an active-level period of gate drive signals corresponding to a group of gate lines, and the group of the data signals is controlled to be output in the active-level period of the gate drive signals corresponding to the group of gate lines.

13. The display panel according to claim 11, wherein two adjacent rows of the gate lines form one group, gate drive signals for gate lines in a same group are controlled to have the same phase, and gate drive signals for gate lines in a next group are controlled to lag gate drive signals for gate lines in a current group by one phase;
each of the plurality of output ports is connected to three demultiplexing circuits, the three demultiplexing circuits control the output port to generate three precharge signals and three data signals; the three precharge signals form one group, the three data signals form one group, and three data lines form one group; and
two adjacent groups of data lines are controlled to receive a same group of precharge signals and a same group of data signals; a group of precharge signals is controlled to be output before an active-level period of gate drive signals corresponding to one group of gate lines, and a group of data signals is controlled to be output in the active-level period of the gate drive signals corresponding to the group of gate lines.

14. The display panel according to claim 11, wherein a gate drive signal for a gate line in a next row is controlled to lag a gate drive signal for a gate line in a current row by half a phase;
each of the plurality of output ports is connected to six demultiplexing circuits, the six demultiplexing circuits control the output ports to generate six precharge signals and six data signals, three precharge signals among the six precharge signals form one group, and three data signals among the six data signals form one group, and three data lines form one group;
one of the two adjacent groups of data lines is controlled to receive one group of precharge signals and data signals, and other group of the data lines is controlled to receive another group of precharge signals and data signals; and
a group of data signals is controlled to be output in a first half of an active-level period of a corresponding group of gate drive signals, and another group of the data signals is controlled to be output in a second half of the active-level period of a corresponding group of gate drive signals.

15. A display device, wherein the display device comprises a display panel according to claim 1.
